(19) United States
(12) Patent Application Publication
(10) Pub. No.: US 2020/0369173 A1
(43) Pub. Date: Nov. 26, 2020

(54) ELECTRIC VEHICLE HAVING WATT-HOUR METER AND MOBILE DISTRIBUTED POWER SOURCE OPERATING SYSTEM

(71) Applicant: KOREA ELECTRIC POWER CORPORATION, Naju-si (KR)

(72) Inventor: Yong Jun KIM, Naju-si (KR)

(21) Appl. No.: 16/958,635

(22) PCT Filed: Sep. 28, 2018
(86) PCT No.: PCT/KR2018/011574

§ 371 Date: Jun. 26, 2020

(30) Foreign Application Priority Data
Dec. 28, 2017 (KR) 10-2017-0182436

(51) Int. Cl. B60L 53/66; B60L 53/16; B60L 53/12; B60L 50/60; B60L 53/65; H02J 7/00

(52) U.S. Cl. CPC B60L 53/665; B60L 53/16; B60L 53/12; H02J 7/00032; B60L 53/65; H02J 7/0045; H02J 7/0047; B60L 50/60

(57) ABSTRACT

An electric vehicle having a watt-hour meter, according to one embodiment of the present invention, can comprise: a battery provided in the electric vehicle; a connector provided in the electric vehicle, and connected to an electric vehicle charger in a wired manner or a short-range wireless manner so as to receive power from the electric vehicle charger and deliver the power to the battery or to receive power from the battery and deliver the power to the electric vehicle charger; a watt-hour meter provided in the electric vehicle and measuring power delivered through the connector; and an output unit provided in the electric vehicle and outputting or remotely transmitting measurement data of the watt-hour meter.

### TECHNICAL FIELD

The present invention relates to an electric vehicle having a watt-hour meter and a mobile distributed power source operating system.

### BACKGROUND ART

Recently, as the problem of depletion of fossil fuels and the problem of air pollution caused by excessive use of fossil fuels become serious, research and development of use of renewable energy and eco-friendly transportations is being actively conducted worldwide. Electric vehicles (EVs) are attracting attention as such eco-friendly transportations.

### DOCUMENT OF PRIOR ART

### Patent Document

(Patent Document 1) Korean Patent Registration No. 10-1684322

### DISCLOSURE

### Technical Problem

The present invention is directed to providing an electric vehicle having a watt-hour meter and a mobile distributed power source operating system.

### Technical Solution

One aspect of the present invention provides an electric vehicle having a watt-hour meter. The electric vehicle includes a battery provided in the electric vehicle, a connector which is provided in the electric vehicle and connected to an electric vehicle charger in a wired manner or a short-range wireless manner so as to receive power from the electric vehicle charger and deliver the power to the battery or to receive power from the battery and deliver the power to the electric vehicle charger, a watt-hour meter which is provided in the electric vehicle and meters the power delivered through the connector, and an output unit which is provided in the electric vehicle and outputs or remotely transmits metering data of the watt-hour meter.

The watt-hour meter may be disposed in the connector.

The output unit may remotely transmit identification information of the electric vehicle together with the metering data.

The output unit may remotely transmit the metering data of the watt-hour meter to a data concentration unit (DCU) for receiving metering data from an electricity receiver watt-hour meter which meters power supplied to the electricity receiver in a power system.

The output unit may remotely transmit the metering data of the watt-hour meter to the electricity receiver watt-hour meter which meters power supplied to the electricity receiver in a power system.

The output unit may generate electric charge information on the basis of the metering data of the watt-hour meter and remotely transmit the electric charge information to a portable terminal.

Another aspect of the present invention provides a mobile distributed power source operating system including a mobile distributed power source, an energy storage unit which is connected to a power system and receives power from the mobile distributed power source, a watt-hour meter which is provided in the mobile distributed power source and meters the power, which is delivered to the energy storage unit by the mobile distributed power source, and an output unit which is provided in the mobile distributed power source and outputs or remotely transmits metering data of the watt-hour meter.

The mobile distributed power source operating system may further include a power generation unit provided in the mobile distributed power source.

### Advantageous Effects

According to embodiments of the present invention, it is possible to provide an environment in which metering data about power charged to an electric vehicle or about power discharged from the electric vehicle is efficiently managed.

Further, according to the embodiments of the present invention, it is possible to provide an environment in which the metering data about the power charged to the electric vehicle or about the power discharged from the electric vehicle is managed together with metering data of an electricity receiver in a power system.

Further, according to the embodiments of the present invention, it is possible to provide an environment in which the metering data about the power charged to the electric vehicle or about the power discharged from the electric vehicle is efficiently provided to a driver of the electric vehicle and the metering data is more accurately generated.

### DESCRIPTION OF DRAWINGS

FIG. 1 is a diagram illustrating an electric vehicle having a watt-hour meter according to an embodiment of the present invention.

FIG. 2 is a diagram illustrating an electric vehicle having a watt-hour meter in more detail according to an embodiment of the present invention.

FIG. 3 is a diagram illustrating an electric vehicle having a watt-hour meter in more detail according to an embodiment of the present invention.

FIG. 4 is an exemplary diagram of an electric vehicle charging station.

FIG. 5 is an exemplary diagram of an electric vehicle charger installed in an electricity receiver.

FIG. 6 is an exemplary diagram of a display of an output unit.

FIG. 7 is an exemplary diagram of a connector.

FIG. 8 is a diagram illustrating a mobile distributed power source operating system according to an embodiment of the present invention.

### MODES OF THE INVENTION

Detailed descriptions of the present invention will be made with reference to the accompanying drawings illustrating specific embodiments of the present invention as examples. It should be understood that various embodiments of the present invention are different but are not necessarily mutually exclusive. For example, a specific shape, structure, and characteristic of an embodiment described herein may be implemented in another embodiment without departing from the scope and spirit of the present invention. In addition, it should be understood that a position or an arrangement of each component in each disclosed embodiment may be changed without departing from the scope and spirit of the present invention. Accordingly, there is no intent to limit the present invention to detailed descriptions to be described below. The scope of the present invention is defined by the appended claims and encompasses all equivalents that fall within the scope of the appended claims. Like numbers refer to the same or like functions throughout the description of the figures.

Hereinafter, in order for those skilled in the art to easily perform the present invention, exemplary embodiments of the present invention will be described in detail with reference to the accompanying drawings.

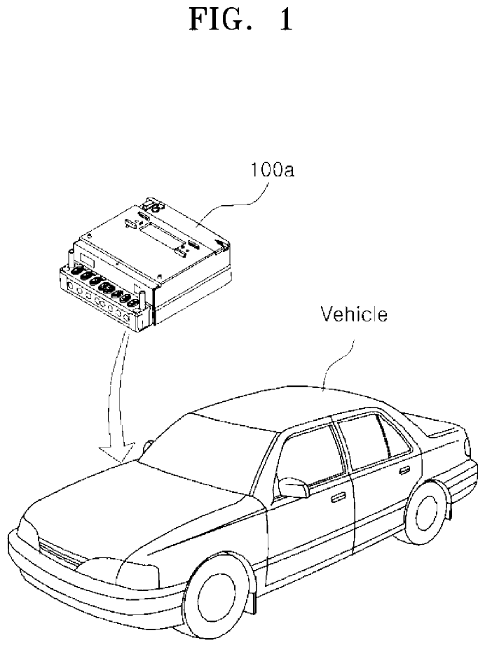

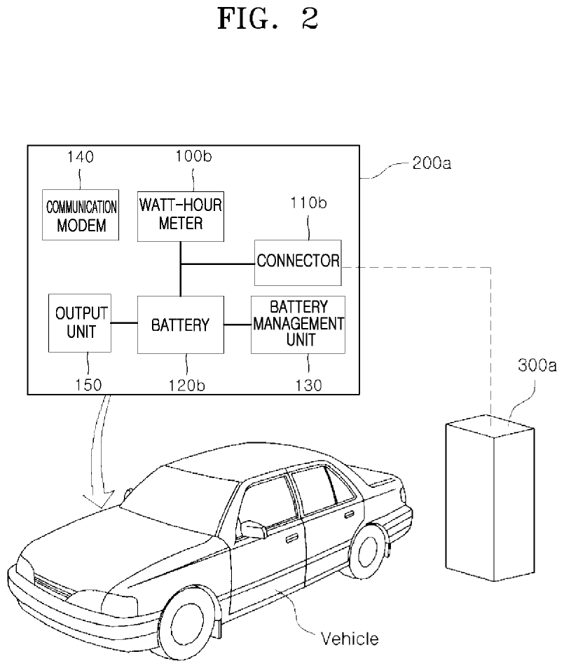

FIG. 1 is a diagram illustrating an electric vehicle having a watt-hour meter according to an embodiment of the present invention, and FIG. 2 is a diagram illustrating an electric vehicle having a watt-hour meter in more detail according to an embodiment of the present invention.

Referring to FIGS. 1 and 2, the electric vehicle having a watt-hour meter according to the embodiment of the present invention may include a watt-hour meter 100a or include a module 200 which includes a watt-hour meter 100b, a connector 110b, a battery 120b, and an output unit 150.

The battery 120b may be provided in the electric vehicle and may provide power, which is required for movement of the electric vehicle, to the electric vehicle. For example, the battery 120b may have a structure in which a plurality of battery cells are connected in series and/or in parallel. The plurality of battery cells may be implemented as a nickel metal battery, a lithium ion battery, etc., but the present invention is not particularly limited thereto.

The battery 120b may include a battery management unit 130. For example, the battery management unit 130 may measure a state of charge of the battery 120b in real time and provide a battery management mode based on a measurement result, may measure a temperature, current, and/or voltage of each of the plurality of battery cells of the battery 120b in real time to perform balancing between the plurality of battery cells based on measurement results, and may block the output of the battery 120b when the temperature, current, and/or voltage of the battery 120b is out of a reference range.

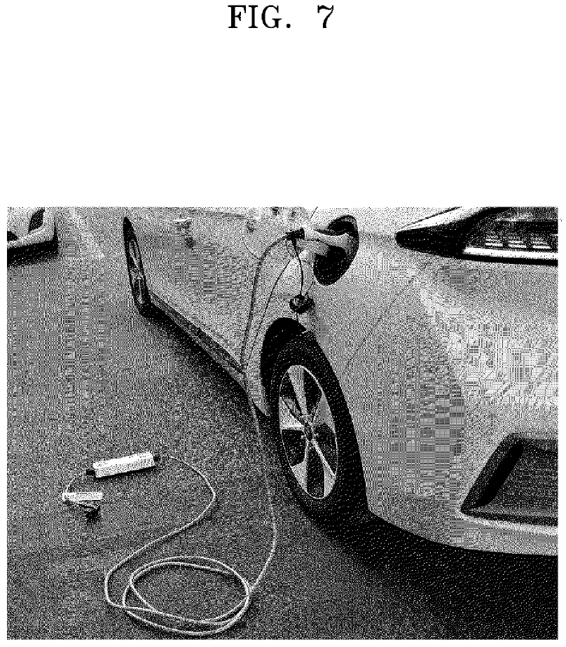

The connector 110b may be provided in the electric vehicle and connected to an electric vehicle charger 300a in a wired manner or in a short-range wireless manner so as to receive power from the electric vehicle charger 300a and deliver the power to the battery 120b or to receive power from the battery 120b and deliver the power to the electric vehicle charger 300a. For example, the connector 110b may have the form of a connection port to which a charging cable of the electric vehicle charger 300a is connected as illustrated in FIG. 7. Depending on the design, the connector 110b may have the form of a charging cable, of which one end is connected to a connection port of the electric vehicle charger 300a and the other end is electrically connected to the battery 120b, or may have a coil shape according to a short-range wireless manner.

The watt-hour meter 100a or 100b may be provided in the electric vehicle and may meter the power delivered through the connector 110b. That is, the power which is charged from the electric vehicle charger 300a to the electric vehicle may be metered by the electric vehicle rather than the electric vehicle charger 300a.

Accordingly, the metering data (e.g., a charge amount, a charge rate, whether rapid charging or slow charging is occurring, whether a current is a direct current (DC) and/or an alternating current (AC), etc.) according to the charging of the electric vehicle may be managed in view of the electric vehicle rather than the electric vehicle charger 300a.

For example, when the electric vehicle is charged from a plurality of electric vehicle chargers for a predetermined period in a distributed manner, the watt-hour meter 100a or 100b may meter the charged power by accumulating the charged power for the predetermined period. Therefore, a user of the electric vehicle may be easily charged with a limp sum of electric charges according to charging instead of being charged with individual electric charges for each of a plurality of electric vehicle chargers. That is, the metering data may be efficiently managed even when the electric vehicle receives power from various electric vehicle chargers.

The output unit 150 may be provided in the electric vehicle and may output the metering data of the watt-hour meter 100a or 100b. For example, the output unit 150 may display the metering data through a dashboard of the electric vehicle in real time while the electric vehicle receives the power. Accordingly, the user of the electric vehicle may conveniently manage the metering data according to the charging.

Further, the output unit 150 may include a communication modem 140 which remotely transmits the metering data of the watt-hour meter 100a or 100b. For example, the communication modem 140 may provide the user with the convenience of management of the metering data by remotely transmitting the metering data to a portable terminal or home of the user of the electric vehicle.

Depending on the design, the communication modem 140 may remotely transmit the metering data to a metering system of a power system, such as an advanced metering infrastructure (AMI). Accordingly, the metering system of the power system may integrally manage metering data of an electricity receiver, such as a house, a building, or a factory, and the metering data of the electric vehicle.

Here, the output unit 150 may remotely transmit identification information of the electric vehicle together with the metering data to the metering system of the power system. Accordingly, the metering system of the power system may use the identification information to manage the electric vehicle as a type of electricity receiver of the power system so that the metering data of the electric vehicle may be more systematically managed. Furthermore, the metering system of the power system may assist to establish a power resale environment and a power transaction environment using the electric vehicle.

For example, the identification information may have vehicle model information of the electric vehicle. Since a conversion power loss caused by DC charging and discharging of the electric vehicle may vary according to the vehicle model, the metering system of the power system may utilize the vehicle model information when compensating for a value corresponding to the conversion power loss in the metering data. Therefore, in the electric vehicle having a watt-hour meter according to the embodiment of the present invention, the accuracy of the metering data with respect to DC charging and discharging may be improved.

For example, the identification information may be matched to an identification number of a watt-hour meter installed in the user's home of the electric vehicle. Accordingly, the user of the electric vehicle may be charged with electric charges for his or her home and electric charges for the vehicle.

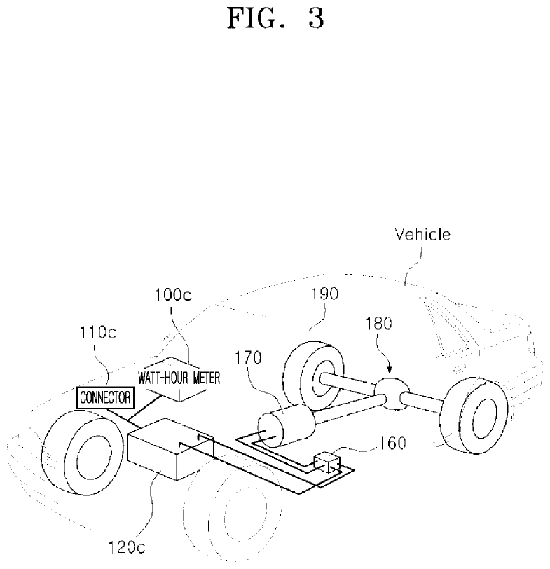

FIG. 3 is a diagram illustrating an electric vehicle having a watt-hour meter in more detail according to an embodiment of the present invention.

Referring to FIG. 3, the electric vehicle having a watt-hour meter according to the embodiment of the present invention may include at least some of a watt-hour meter 100c, a connector 110c, a battery 120c, a control unit 160, a driving unit 170, a transmission 180, and wheels 190.

The connector 110c may be electrically connected to each of the watt-hour meter 100c and the battery 120c.

Depending on the design, the watt-hour meter 100c may be disposed in the connector 110c. Accordingly, the watt-hour meter 100c may be easily provided in the electric vehicle even with no large change in a structure of the electric vehicle.

For example, the connector 110c may have a structure in which a metal member (not illustrated) through which power passes and an insulating member (not illustrated) which surrounds at least a part of the metal member are coupled. Here, the watt-hour meter 100c may have an integrated structure with respect to the insulating member.

The control unit 160 may receive a control signal from the user of the electric vehicle, receive power from the battery 120c in response to the control signal, and transmit the received power to the driving unit 170.

The driving unit 170 may convert the received power into motive power, the transmission 180 may control characteristics of the motive power, and the wheels 190 may be rotated according to the motive power to move the electric vehicle.

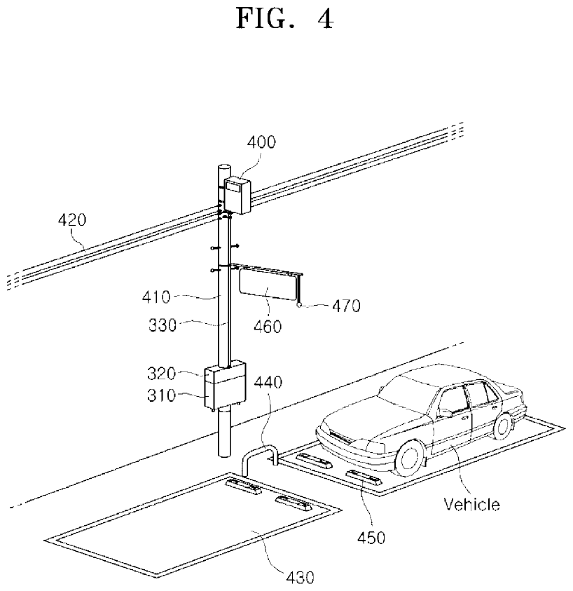

FIG. 4 is an exemplary diagram of an electric vehicle charging station.

Referring to FIG. 4, in the electric vehicle charging station, at least some of an electric vehicle charger 310, an intelligent power distribution box 320, a power cable 330, a data concentration unit 400, an electric pole 410, a power distribution line 420, a parking space 430, a vehicle collision prevention bollard 440, a vehicle stopper 450, a charging station display board 460, and an imaging unit 470 may be disposed.

The electric vehicle charger 310 may be installed on the electric pole 410 and configured to receive power from an electric transformer (e.g., a pole transformer or a ground transformer) and charge an electric vehicle. For example, the electric vehicle charger 310 may be electrically connected to the power distribution line 420 through the power cable 330 to receive the power and may perform AC-to-DC conversion using a converter.

The intelligent power distribution box 320 may receive information for controlling the electric vehicle charger 310 from the electric vehicle or the user of the electric vehicle, and control a charging amount, whether or not charging is occurring, a charging mode, etc. of the electric vehicle charger 310 on the basis of the above information. Depending on the design, the intelligent power distribution box 320 and the electric vehicle charger 310 may be integrated.

The power cable 330 may be installed along the electric pole 410. However, when the power distribution line 420 is disposed under the ground, the power cable 330 may have a structure in which at least a part of the power cable 330 is disposed under the ground, or the power cable 330 may be electrically connected to a ground transformer.

The data concentration unit 400 may receive metering data from an electricity receiver watt-hour meter that meters power supplied to the electricity receiver, such as a house, a building, or a factory, in a power system, may receive concentratedly metering data of each of a plurality of electricity receiver watt-hour meters, and may remotely transmit the received metering data to a metering system of the power system, such as an AMI.

Here, the output unit included in the electric vehicle may remotely transmit the metering data of the power received from the electric vehicle charger 310 to the data concentration unit 400. The data concentration unit 400 may remotely transmit the metering data of the electric vehicle together with the metering data of the electricity receiver to the metering system of the power system. Therefore, the metering system of the power system may integrally manage the metering data of the electric vehicle and the metering data of the electricity receiver, such as a house, a building, or a factory.

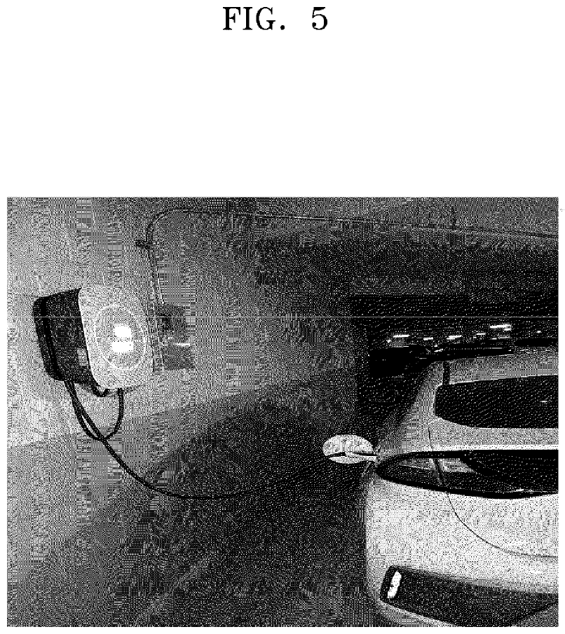

FIG. 5 is an exemplary diagram of the electric vehicle charger installed in the electricity receiver.

Referring to FIG. 5, the electric vehicle charger may be installed on an electricity receiver (e.g., an underground parking lot in an apartment). For example, the electric vehicle charger may be installed adjacent to the electricity receiver watt-hour meter that meters power supplied to the electricity receiver in the power system.

The output unit included in the electric vehicle may remotely transmit the metering data of the electric vehicle to the electricity receiver watt-hour meter. Accordingly, the electricity receiver watt-hour meter may transmit the metering data of the electricity receiver and the metering data of the electric vehicle to the data concentration unit or may directly transmit the metering data of the electricity receiver and the metering data of the electric vehicle to the metering system of the power system.

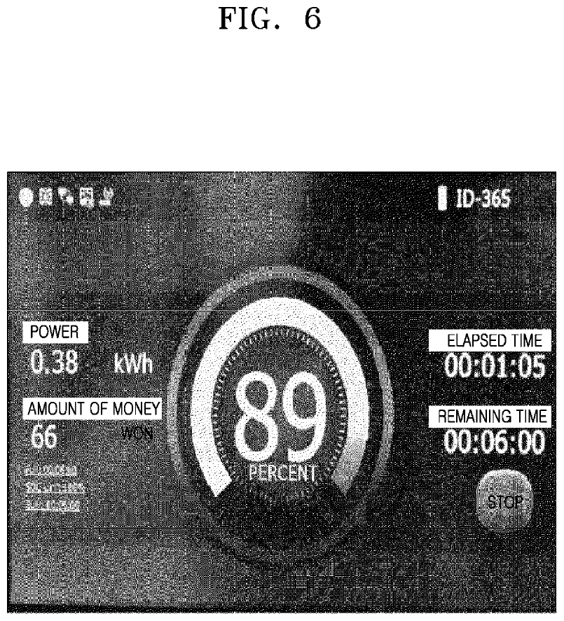

FIG. 6 is an exemplary diagram of a display of the output unit.

Referring to FIG. 6, the output unit included in the electric vehicle may display various types of metering data (e.g., a charging amount, a charging rate, a charging time, an expected charging time, a charging progress rate, etc.). For example, the display may be displayed through a dashboard of the electric vehicle.

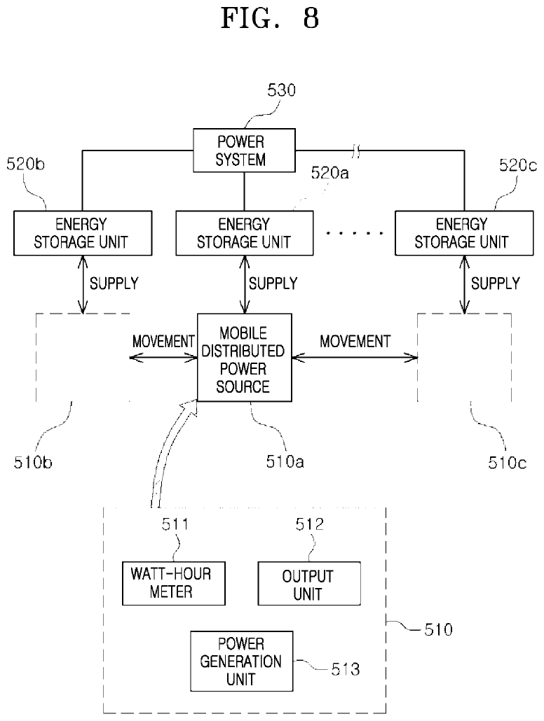

FIG. 8 is a diagram illustrating a mobile distributed power source operating system according to an embodiment of the present invention.

Referring to FIG. 8, the mobile distributed power source operating system according to the embodiment of the present invention may include a mobile distributed power source 510a, a watt-hour meter 511, an output unit 512, and an energy storage unit 520a and may further include a power generation unit 513.

The mobile distributed power source 510a may be a commercial electric vehicle or may be an electric vehicle configured to supply power to a power system.

For example, the mobile distributed power source 510a may store power, which is generated by the power generation unit 513 in a region in which the power generation unit 513 may efficiently generate power, in a battery having a large capacity and may move to regions 510b and 510c adjacent to energy storage units 520a, 520b, and 520c of a power facility to supply the power to the power system.

The watt-hour meter 511 may be provided in the mobile distributed power source 510a and may meter the power, which is delivered to the energy storage units 520a, 520b, and 520c by the mobile distributed power source 510a.

The output unit 512 may be provided in the mobile distributed power source 510a and may output or remotely transmit metering data of the watt-hour meter 511.

The energy storage units 520a, 520b, and 520c may be connected to the power system 530 and may receive the power from the mobile distributed power source 510a.

Therefore, the power system 530 may more efficiently operate the energy storage units 520a, 520b, and 520c using the mobile distributed power source 510a. For example, when a state of charge of some of the energy storage units 520a, 520b, and 520c is low or a load increases rapidly, the mobile distributed power source 510a may move to the energy storage unit, of which the state of charge is low or the load increases rapidly, and transmit the power to the energy storage unit.

Meanwhile, the module 200a described in this specification may perform processing (e.g., data operation, data format conversion, etc.) on the metering data using processors (e.g., a central processing unit (CPU), a graphics processing unit (GPU), a microprocessor, an application-specific integrated circuit (ASIC), a field programmable gate array (FPGA), etc.) and memories (e.g., a random access memory (RAM), a read only memory (ROM), a flash memory, a magnetic storage, an optical storage, etc.), but the present invention is not limited thereto.

The communication modem 140 described in this specification may be implemented as a communication connection unit, such as a modem, a network interface card (NIC), an integrated network interface, a radio frequency transmitter and/or electricity receiver, an infrared port, or a Universal Serial Bus (USB) connection unit, and may support a format according to any other wireless or wired protocols designated as Wi-Fi (the Institute of Electrical and Electronics Engineers (IEEE) 802.11 family, etc.), Worldwide Interoperability for Microwave Access (WiMAX: IEEE 802.16 family, etc.), IEEE 802.20, Long-Term Evolution (LTE), Evolution-Data Optimized (EV-DO), High Speed Packet Access Plus (HSPA+), High Speed Downlink Packet Access Plus (HSDPA+), High-Speed Uplink Packet Access Plus (HSUPA+), Enhanced Data rates for GSM Evolution (EDGE), Global System for Mobile Communications (GSM), Global Positioning System (GPS), General Packet Radio Service (GPRS), Code-division multiple access (CDMA), Time-division multiple access (TDMA), Digital enhanced cordless telecommunications (DECT), Bluetooth, or a 3rd generation (3G)-, 4th generation (4G)-, 5th generation (5G)-, or later generation protocol, but the present invention is not limited thereto.

While embodiments of the present invention have been illustrated and described above, the present invention is not limited to the embodiments. Those skilled in the art may variously modify the present invention without departing from the gist of the present invention claimed by the appended claims.

1. An electric vehicle having a watt-hour meter, the electric vehicle comprising:
a battery provided in the electric vehicle;
a connector which is provided in the electric vehicle and connected to an electric vehicle charger in a wired manner or a short-range wireless manner so as to receive power from the electric vehicle charger and deliver the power to the battery or to receive power from the battery and deliver the power to the electric vehicle charger;
a watt-hour meter which is provided in the electric vehicle and meters the power delivered through the connector; and
an output unit which is provided in the electric vehicle and outputs or remotely transmits metering data of the watt-hour meter.

2. The electric vehicle of claim 1, wherein the watt-hour meter is disposed in the connector.

3. The electric vehicle of claim 1, wherein the output unit remotely transmits identification information of the electric vehicle together with the metering data.

4. The electric vehicle of claim 1, wherein the output unit remotely transmits the metering data of the watt-hour meter to a data concentration unit (DCU) for receiving metering data from an electricity receiver watt-hour meter which meters power supplied to the electricity receiver in a power system.

5. The electric vehicle of claim 1, wherein the output unit remotely transmits the metering data of the watt-hour meter to an electricity receiver watt-hour meter which meters power supplied to the electricity receiver in a power system.

6. The electric vehicle of claim 1, wherein the output unit generates electric charge information on the basis of the metering data of the watt-hour meter and remotely transmits the electric charge information to a portable terminal.

7. A mobile distributed power source operating system comprising:
a mobile distributed power source;
an energy storage unit which is connected to a power system and receives power from the mobile distributed power source;
a watt-hour meter which is provided in the mobile distributed power source and meters the power, which is delivered to the energy storage unit by the mobile distributed power source; and
an output unit which is provided in the mobile distributed power source and outputs or remotely transmits metering data of the watt-hour meter.

8. The mobile distributed power source operating system of claim 7, further comprising a power generation unit provided in the mobile distributed power source.
